(19) United States
(12) Patent Application Publication
(10) Pub. No.: US 2026/0265520 A1
(43) Pub. Date: Sep. 10, 2026

(54) SHELF STABLE THERMALLY CONDUCTIVE REACTIVE COMPOUNDS AND METHODS

(71) Applicant: LORD CORPORATION, Cary, NC (US)

(72) Inventors: Timothy D. Fornes, Apex, NC (US); Lauren E. Ledbetter, New Hill, NC (US)

(73) Assignee: LORD CORPORATION, Cary, NC (US)

(21) Appl. No.: 19/160,967

(22) PCT Filed: May 31, 2024
(86) PCT No.: PCT/US2024/031861

§ 371 Date: Aug. 29, 2025

Related U.S. Application Data
(60) Provisional application No. 63/470,363, filed on Jun. 1, 2023.

(51) Int. Cl. C08L 75/00; C08K 3/013

(52) U.S. Cl. CPC C08L 75/00; C08K 3/013; C08K 2201/001; C08K 2201/019

(57) ABSTRACT

Filled compounds, including thermally conductive materials and compositions. The filled compounds include isocyanate reactive resins, conductive fillers, and isocyanate resins. The filled compounds can include two components, one with the isocyanate reactive resin and conductive filler, and a second with the isocyanate resin.

### PRIORITY CLAIM

The present application claims priority to U.S. Provisional Patent Application Ser. No. 63/470,363, filed Jun. 1, 2023, the disclosure of which is incorporated herein by reference in its entirety.

### TECHNICAL FIELD

The presently disclosed subject matter relates to shelf stable thermally conductive reactive compounds and methods.

### BACKGROUND

Thermally conductive compounds are heavily used in applications such as electronic devices and battery systems to control temperature levels for performance and reliability reasons. Two component (2K), thermally conductive urethanes represent one class of thermally conductive compounds. Urethane chemistries, and derivatives thereof, i.e. the class materials representing product of a reaction of an isocyanate reactive compound and an isocyanate, are well known for the reaction products that possess unique combinations of properties such as adhesion, strength, stiffness, and ductility. The broad commercial availability of a plethora of isocyanate reactive and isocyanates also makes them attractive to the manufacturers of urethane compounds and end users due to the raw material affordability and formulation versatility.

Despite this attractiveness, thermally conductive urethane compounds suffer numerous drawbacks due to isocyanate's high reactivity with water which is present in/on the thermally conductive fillers. Manufacturers of said compounds are thus forced to go to extensive measures to try to remove the water before and/or during incorporation of the filler in the isocyanate containing component of 2K formulations. Measures may include instituting costly large drying ovens and associated handling equipment, incorporation of molecular sieves for absorbing water, and extensively mixing the formulation for prolonged periods of time and temperature to react any moisture remaining on the filler with that of the isocyanate. Even with incorporating these measures it can be impossible to remove firmly bound adsorbed water which over time eventually reacts with the isocyanate over the course of the material's shelf-life. The reaction between the water and the isocyanate causes unacceptable increases in viscosity, undesirable higher molecular weight urea species, and affects the final performance of the reacted 2K system formed from the reaction of the isocyanate containing component with that of the isocyanate reactive component. In addition, extra steps must be taken to package the isocyanate containing component from the environment to prevent moisture ingress over time, especially when the material contains hydroscopic thermally conductive fillers.

In addition to drying limitations, manufacturers of thermally conductive compounds are also restricted to the type and size of filler used in the isocyanate containing compound as well as the type of isocyanate itself. For example, aluminum trihydrate (ATH), because of its highly polar nature readily adsorbs large amounts of water. The level of water adsorption per unit gram is a function of the particles size, shape, and collectively surface area. Particles smaller in diameter as well as those with non-spherical shapes possess higher surface areas and in turn adsorb more water than larger particles that are more spherical. It is for these reasons that manufacturers must avoid such hydroscopic fillers to prevent issues with shelf-life as mentioned above.

In the case of the isocyanate component of the thermally conductive 2K system, manufacturers are restricted to use less reactive classes of isocyanates, e.g. aliphatic isocyanate, versus aromatic isocyanates. Although this affords the preparation of volumetrically balanced 1:1 2K systems, such aliphatic isocyanates may add significantly more cost and offer less than desirable performance such as strength, modulus, and glass transition temperature. Moreover, aliphatic isocyanates still suffer shelf-life limitations in the presence of hydroscopic fillers as previously described.

It is thus desirable, and there remains a significant need, to create very shelf-stable, 2K thermally conductive compounds based on isocyanates that enable the use of hydroscopic fillers, employment of more reactive isocyanates, and/or the reduction and/or elimination of filler drying processes. Such compounds are provided herein.

### SUMMARY

This summary lists several embodiments of the presently disclosed subject matter, and in many cases lists variations and permutations of these embodiments. This summary is merely an example of the numerous and varied embodiments. Mention of one or more representative features of a given embodiment is likewise for purposes of example. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

Provided herein are filled compounds comprising an isocyanate reactive resin; a conductive filler; and an isocyanate resin. In some embodiments, the isocyanate reactive resin and conductive filler are included in a first component, and the isocyanate resin is included in a second component. In some embodiments, the first and second components are configured to be mixed to react to form a thermally conductive compound, wherein the first component and the second component are mixed at a ratio of about 1:1 to about 50:1. In some embodiments, the first component and the second component are mixed at a ratio of about 1:1, about 2:1, about 3:1, about 4:1, about 5:1, about 6:1, about 7:1, about 8:1, about 9:1, about 10:1, about 11:1, about 12:1, about 15:1, about 20:1, about 25:1, about 30:1, about 35:1, about 40:1, about 45:1, or about 50:1, preferably about 1:1.

In some embodiments, the isocyanate reactive resin comprises a resin type selected from the group consisting of a polyether, polyester, and aliphatic hydrocarbon. In some embodiments, the isocyanate reactive resin comprises at least two active hydrogen atoms that are selected from the group consisting of a hydroxyl, primary amine, secondary amine, thiol, urethane, urea, carboxylic acid, amide, and water. In some embodiments, the isocyanate reactive resin comprises a polyethylene glycol, polypropylene glycol, polytetramethylene ether glycol, a castor oil-based polyester polyol, and/or a polybutadiene-based aliphatic polyol. In some embodiments, the isocyanate resin comprises an aromatic isocyanate, an aliphatic isocyanate, or an isocyanate prepolymer. In some embodiments, the aromatic isocyanate resin comprises a monomer or polyisocyanate based on methylene diphenyl diisocyanate (MDI) or toluene diisocyanate (TDI). In some embodiments, the aliphatic isocyanate resin comprises a monomeric isocyanate or polyisocyanate based on hexamethylene diisocyanate (HDI), hydrogenated MDI, or isophorone diisocyanate. In some embodiments, the isocyanate prepolymer comprises a reaction product of an isocyanate reactive resin and an aromatic isocyanate resin. In some embodiments, the isocyanate prepolymer comprises a reaction product of a polyether polyol and an MDI-based resin. In some embodiments, the isocyanate prepolymer comprises a reaction product of an isocyanate reactive resin and an aliphatic isocyanate resin. In some embodiments, the isocyanate prepolymer comprises a reaction product of a polyether polyol and an HDI-based resin.

The conductive filler can in some aspects comprise aluminum, aluminum trihydrate, aluminum oxide, silica, calcium carbonate, magnesium oxide, and/or magnesium hydroxide, optionally wherein the conductive filler is greater than about 5 W/m·K. In some embodiments, the first component comprises undried thermally conductive filler, and optionally a moisture scavenger. In some embodiments, the first component comprises a dried filler and no molecular sieves.

In some embodiments, the thermal conductivity ranges from about 0.5 W/m·K to about 10 W/m·K or more, optionally about 1 W/m·K to about 4 W/m·K. In some embodiments, the filled compound is used as a thermal interface material. In some embodiments, the filled compound is used as an encapsulant or potting compound. In some embodiments, the thermal interface material is shelf-stable. In some embodiments, the filled compound comprises a thermally conductive filler, a reinforcing filler, cost reducing filler, surface modifying filler, electrically conductive filler, magnetic filler, density reducing filler, and/or combinations thereof.

Disclosed herein are methods of making a shelf-stable thermal interface material, the methods comprising mixing the first component of the disclosed filled compounds with the second component of the disclosed filled compounds. In some aspects, the method comprises ensuring there is no thermally conductive filler in the second component.

In some embodiments, such methods comprise selecting a desired thermal conductivity; selecting isocyanate-reactive and isocyanate-containing compounds to be used in a first component and a second component, respectively; selecting a desired thermally conductive filler package; determining a filler loading by volume, φ_{f_mixed}, in mixed formulation to achieve the desired thermal conductivity; determining the maximum filler loading by volume, φ_{f_max_1}, that can be added into the first component, while still maintaining a flowable material; calculating the minimum mix ratio of the first component to the second component, using the formula Rₘᵢₙ=φ_{f_mixed}/(φ_{f_max_1}−φ_{f_mixed}); selecting a method to dispense, e.g. cartridge dispensing, meter-mix-dispensing, the material; selecting a mix ratio, R, of the first component to the second component (where R≥Rₘᵢₙ); and optimizing and/or adjusting compositions of the first and second components to achieve total performance needs, optionally involving repeating the above steps. In some embodiments, the methods further comprise a step of adjusting isocyanate-reactive and isocyanate concentrations on the first component and second component, respectively, to achieve a desired NCO index, optionally after the step of selecting a method to dispense.

These and other objects are achieved in whole or in part by the presently disclosed subject matter. Other objects and advantages of the presently disclosed subject matter will become apparent to those skilled in the art after a study of the following description, Drawings and Examples.

### BRIEF DESCRIPTION OF THE DRAWINGS

The presently disclosed subject matter can be better understood by referring to the following, example figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawing. Although the illustrated embodiment(s) is/are merely for purposes of example for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and provide examples of the presently disclosed subject matter.

For a more complete understanding of the presently disclosed subject matter, reference is now made to the following drawings in which:

FIG. 1 is a graphical depiction of the data from experiments illustrating the differences in viscosity as a function of storage time for aliphatic isocyanate-based, thermally conductive reactive compounds, as discussed in the Examples.

FIG. 2 is a graphical depiction of the data from experiments illustrating the differences in viscosity as a function of storage time for aromatic isocyanate-based thermally conductive reactive compounds, as discussed in the Examples.

FIG. 3 is a flow chart of a method of making a shelf-stable, thermally conductive reactive compound of the presently disclosed subject matter.

### DETAILED DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

### I. Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, sequence identity (e.g., when comparing two or more nucleotide or amino acid sequences), mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

As used herein, the term “isocyanate” refers to a group of reactive, low molecular weight aromatic, and aliphatic compounds containing the isocyanate group (—NCO). Organic compounds that contain one isocyanate group are termed isocyanates. Isocyanates that contain more than one isocyanate groups are known as polyisocyanates. Isocyanates and polyisocyanates can be used in the production of polyurethanes.

Exemplary polyisocyanates include ethylene diisocyanate, trimethylene diisocyanate, hexamethylene diisocyanate, propylene-1,2-diisocyanate, ethylidene diisocyanate, cyclopentylene-1,3-diisocyanate, the 1,2-, 1,3- and 1,4-cyclohexylene diisocyanates, the 1,3- and 1,4-phenylene diisocyanates, diphenylmethane diisocyanates, polymethyleneisocyanates, the 2,4- and 2,6-toluene diisocyanates, the 1,3- and 1,4-xylylene diisocyanates, bis(4-isocyanatoethyl)carbonate, 1,8-diisocyanato-p-methane, 1-methyl-2,4-diisocyanatocyclohexane, the chlorophenylene diisocyanates, naphthalene-1,5-diisocyanate triphenylmethane-4,4′, triisocyanate, isopropylbenzene-alpha-4-diisocyanate, 5,6-bicyclo[2.2.1]hept-2-ene diisocyanate, 5,6-diisocyanatobutylbicyclo[2.2.1]hept-2-ene.

Examples of alicyclic polyisocyanates include 1,3-cyclopentene diisocyanate, 1,4-cyclohexane diisocyanate, 1,3-cyclohexane diisocyanate, 1-isocyanato-3,3,5-trimethyl-5-isocyanatomethyl-cyclohexane (isophorone diisocyanate, IPDI), 4,4′-methylenebis(cyclohexyl isocyanate), methyl-2,4-cyclohexane diisocyanate, methyl-2,6-cyclohexane diisocyanate and 1,3- or 1,4-bis(isocyanatomethyl)cyclohexane) and polyisocyanates (e.g., 1,3,5-triisocyanatocyclohexane, 1,3,5-trimethylisocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo(2.2.1)heptane, 5-(2-isocyanatoethyl)-2-isocyanatomethyl-3-(3-isocyanatopropyl)-bicyclo(2.2.1)heptane, 6-(2-isocyanatoethyl)-2-isocyanatomethyl-3-(3-isocyanatopropyl)-bicyclo(2.2.1)heptane, 5-(2-isocyanatoethyl)-2-isocyanatomethyl-2-(3-isocyanatopropyl)-bicyclo(2.2.1)-heptane and 6-(2-isocyanatoethyl)-2-isocyanatomethyl-2-(3-isocyanatopropyl)-bicyclo(2.2.1)heptane).

Polyisocyanates are also discussed in U.S. Pat. No. 4,553,377, and citing U.S. Pat. Nos. 6,221,995; 6,201,060; 6,153,690; 6,143,132; 6,139,675; 6,126,777; 6,087,439; 6,080,812; 6,051,634; 6,034,169; 6,008,289; 6,007,619 and 5,998,539. The isocyanate-functional prepolymers which are suitable for producing the olefinic urethane reaction product are well-known. Typically, such prepolymers are adducts or condensation products of polyisocyanate compounds having at least two free isocyanate groups and monomeric or polymeric polyols having at least two hydroxy groups, including mixtures of such polyols. The reaction between the polyisocyanate and the polyols is effected by employing an excess amount of polyisocyanate to ensure that the isocyanate-functional prepolymer will contain at least two free, unreacted isocyanate groups.

Polyisocyanates which can be reacted with polyols to form isocyanate-functional prepolymers can be any isocyanate compound having at least two free isocyanate groups, including aliphatic, cycloaliphatic and aromatic compounds.

Representative isocyanates include, without limitation, 2,4-toluene diisocyanate, 2,6-toluene diisocyanate, methylene diphenyl diisocyanates such as 2,4′-diphenylmethane diisocyanate, 4,4′-diphenylmethane diisocyanate, m- and p-phenylene diisocyanate, polymethylene poly(phenyl isocyanate), hexamethylene diisocyanate, 4,4′-methlenebis(cyclohexyl isocyanate), isophorone diisocyanate, and other aliphatic, heterocyclic and aromatic polyisocyanates, and including mixtures of such polyisocyanates.

Isocyanates are reactive toward a variety of nucleophiles including alcohols, amines, and even water having a higher reactivity compared to structurally analogous isothiocyanates. As discussed herein, “isocyanate reactive compounds” or “isocyanate reactive resins” include components that are reactive with isocyanates and are selected for their reactivity to the same. Examples include, but are not limited to a resin type of “isocyanate reactive resin” selected from the group consisting of a polyether, polyester, and aliphatic hydrocarbon. Additionally, isocyanate reactive resins can include those with at least two active hydrogen atoms that are selected from the group consisting of a hydroxyl, primary amine, secondary amine, thiol, urethane, urea, carboxylic acid, amide, and water. Finally, an isocyanate reactive resin can include a polyethylene glycol, polypropylene glycol, polytetramethylene ether glycol, a castor oil-based polyester polyol, and/or a polybutadiene-based aliphatic polyol.

The term “thermally conductive filler” refers to compositions to enhance thermal conductivity of a component(s) to which it is added. Thus, a thermally conductive filler can be selected from a wide variety of thermally conductive particulate compositions including aluminum, aluminum nitride, aluminum oxide (or alumina), aluminum trihydrate (ATH), beryllium oxide, boron nitride, carbon black, calcium carbonate, graphite, magnesium oxide (or magnesia), magnesium hydroxide, silicon carbide, silicon dioxide (or silica), talc, titanium dioxide zinc oxide, and other minerals. Preferred thermally conductive fillers include aluminum, aluminum trihydrate, aluminum oxide, silica, calcium carbonate, magnesium oxide, and/or magnesium, and any combination thereof. Typically, the thermally conductive filler is microparticulate powder having an average particle size ranging from about 0.1 to about 300 microns, and preferably from about 0.3 to about 80 microns.

As disclosed herein, often times components are separated in a two-part form, i.e., 2K, especially when the components can react with each other, for example when an isocyanate is used. In such embodiments, the isocyanate is typically separated from other components other than the carrier solvent or at least other components capable of reacting under ambient (storage) conditions.

As used herein, the term “NCO Index” refers to the ratio of total NCO equivalents within the isocyanate component (Component 2) to the total of reactive equivalents within the isocyanate-reactive component (Component 1). In another embodiment, the NCO Index can also be expressed as the NCO/OH ratio for 2K systems based on isocyanates and polyols.

Catalysts can be used to control the rate curing of isocyanate-reactive and isocyanate species disclosed within the embodied compositions. Catalysts are most often of the nucleophilic type, primarily represented by bases such as tertiary amines and salts of weak acids, or the electrophilic type, primarily represented by organic metal compounds. Specific examples include, but are not limited to, trialkylamines, peralkyated aliphatic polyamines, diazabicyclooctane, tin dioctoate, dibutyl tin dilaurate, and N-alkyl morpholine.

Although not essential to the core aspect of the presently disclosed subject matter, the following items are common components used in 2K formulations for controlling such properties as color, rheology, flammability, improving adhesion, mechanical properties, foaming, among other things. Such common components may consist of, but are not limited to, pigments, viscosity reducing additives, shear thinning additives, flame retardants, adhesion promoters, plasticizers, foaming stabilizers, and surfactants. Such materials, being non-essential to the disclosed and claimed subject matter, have been denoted “additive package” herein.

As used herein, a “monomer” refers to a molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2-10) of repetitive units derived from molecules of lower relative molecular mass.

A “polymer” refers to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units.

A “copolymer” refers to a polymer derived from more than one species of monomer.

As used herein, the term “room temperature” is considered to be any temperature between about 15° C. and about 25° C. (i.e., about 15, 16, 17, 18, 19, 20, 21, 22, 23, 24, or about 25° C.). In some embodiments, the term “room temperature” is a temperature between about 18° C. and about 24° C. or between about 20° C. and about 25° C.

As used herein, the term “shelf-stable” refers to a component which composition and morphology is not significantly altered to compromise its physical and chemical properties (e.g. viscosity, reactive equivalence) such that the material is no longer dispensable and capable of adequately curing with the first (isocyanate-reactive) component needed to achieve the performance expectations of the unaged version of the cured formulation. Shelf-stability can be of particular concern when incorporating high concentrations of and/or high surface particles, e.g. ATH, into isocyanate resins. ATH, being highly hydroscopic, can lead to water-isocyanate reactions over time that compromise the % reactive isocyanate (“NCO content”) moieties, thereby leading to molecular weight increases, crosslinking, viscosity increases and the like. Furthermore, the isocyanate component possessing lower NCO content and potential higher viscosity, when mixed with the polyol component, can compromise the properties of the cured urethane material.

### II. Shelf Stable Thermally Conductive Reactive Compounds and Methods

Disclosed herein are filled compounds comprising an isocyanate reactive resin, a conductive filler, and an isocyanate resin. In some embodiments, the isocyanate reactive resin and conductive filler are included in a first component, while the isocyanate resin is included in a second component. In some aspects, the first and second components are configured to be mixed to react to form a thermally conductive compound, wherein the first component and the second component are mixed at a ratio of about 1:1 to about 50:1. Optionally, the first component and the second component are mixed at a ratio of about 1:1, about 2:1, about 3:1, about 4:1, about 5:1, about 6:1, about 7:1, about 8:1, about 9:1, about 10:1, about 11:1, about 12:1, about 15:1, about 20:1, about 25:1, about 30:1, about 35:1, about 40:1, about 45:1, or about 50:1, preferably about 1:1.

In some aspects, the isocyanate reactive resin comprises a resin type selected from the group consisting of a polyether, polyester, and aliphatic hydrocarbon. In some aspects, the isocyanate reactive resin comprises at least two active hydrogen atoms that are selected from the group consisting of a hydroxyl, primary amine, secondary amine, thiol, urethane, urea, carboxylic acid, amide, and water. In some aspects, the isocyanate reactive resin comprises a polyethylene glycol, polypropylene glycol, polytetramethylene ether glycol, a castor oil-based polyester polyol, and/or a polybutadiene-based aliphatic polyol. In some aspects, the isocyanate resin comprises an aromatic isocyanate, an aliphatic isocyanate, or an isocyanate prepolymer.

Aromatic isocyanate resins can comprise a monomer or polyisocyanate based on methylene diphenyl diisocyanate (MDI) or toluene diisocyanate (TDI). Aliphatic isocyanate resins can include monomeric isocyanate or polyisocyanate based on hexamethylene diisocyanate (HDI), hydrogenated MDI, or isophorone diisocyanate.

In some embodiments, where an isocyanate prepolymer is used in the disclosed filled compounds, the isocyanate prepolymer can include a reaction product of an isocyanate reactive resin and an aromatic isocyanate resin. The isocyanate prepolymer comprises a reaction product of a polyether polyol and an MDI-based resin. Optionally, the isocyanate prepolymer comprises a reaction product of an isocyanate reactive resin and an aliphatic isocyanate resin. In some aspects, the isocyanate prepolymer comprises a reaction product of a polyether polyol and a HDI-based resin.

In some aspects, the conductive filler comprises aluminum, aluminum trihydrate, aluminum oxide, silica, calcium carbonate, magnesium oxide, and/or magnesium hydroxide, optionally wherein the conductive filler is greater than about 5 W/m·K.

In some aspects, the first component comprises undried thermally conductive filler, and optionally a moisture scavenger. In some aspects, the first component comprises a dried filler and no molecular sieves.

The thermal conductivity of the disclosed filled compounds can range from about 0.5 W/m·K to about 10 W/m·K or more, optionally about 1 W/m·K to about 4 w/m·K, optionally 0.5 W/m·K, 1 W/m·K, 1.5 W/m·K, 2 W/m·K, 2.5 W/m·K, 3 W/m·K, 3.5 W/m·K, 4 W/m·K, 4.5 W/m·K, 5 W/m·K, 5.5 W/m·K, 6 W/m·K, 6.5 W/m·K, 7 W/m·K, 7.5 W/m·K, 8 W/m·K, 8.5 W/m·K, 9 W/m·K, 9.5 W/m·K, or 10 W/m·K.

As discussed herein, the filled compound can be used as a thermal interface material. Optionally, the filled compound is used as an encapsulant or potting compound. Advantageously, the thermal interface material is designed to be shelf-stable. The thermal interface material can be formed by mixing the first component with the second component as discussed herein. Additionally, the filled compound comprises a thermally conductive filler, a reinforcing filler, cost reducing filler, surface modifying filler, electrically conductive filler, magnetic filler, density reducing filler, and/or combinations thereof.

In a further embodiment, the presently disclosed subject matter allows for the use of undried thermally conductive filler when the incoming moisture inherent to the filler can be removed via high temperature processing and vacuum during the preparation of the first component. In yet a further embodiment, the presently disclosed subject matter provides for the use of undried thermally conductive filler where the incoming moisture inherent to the filler can be removed thorough incorporation of a moisture scavenger present in the first component. Examples of moisture scavengers include, but are not limited to, molecular sieves, p-toluenesulfonyl isocyanate, and oxazolidine compounds. In a further embodiment, water is purposely added to the first component comprising undried or dried thermally conductivity filler to create a thermally conductive foam formed by mixing the first component with the second component.

In a further embodiment, the presently disclosed subject matter may be suited for use as thermally conductive compound for applications that must be kept within a desired operating temperature range for safety and reliability reasons. Such applications may include, but are not limited to, batteries, battery modules, battery packs, electric vehicle assemblies, power conversion systems, inductors, transformers, inverters, electrical chokes, AC filters, thermistors, transistors, microprocessor chips, heat spreaders, heat sinks, thermally conductive underfills for flip chip applications, chargers, control modules, printed circuit boards, electrical switches, and electrical motors.

In some embodiments, the disclosed subject matter can exist in the form of and/or in the preparation of a potting compound, encapsulant, gap filler, adhesive, tape, pad, a coating that is pre-applied to a substrate (e.g. dielectric coating) that is to be later bonded by another TIM or traditional adhesive to another substrate.

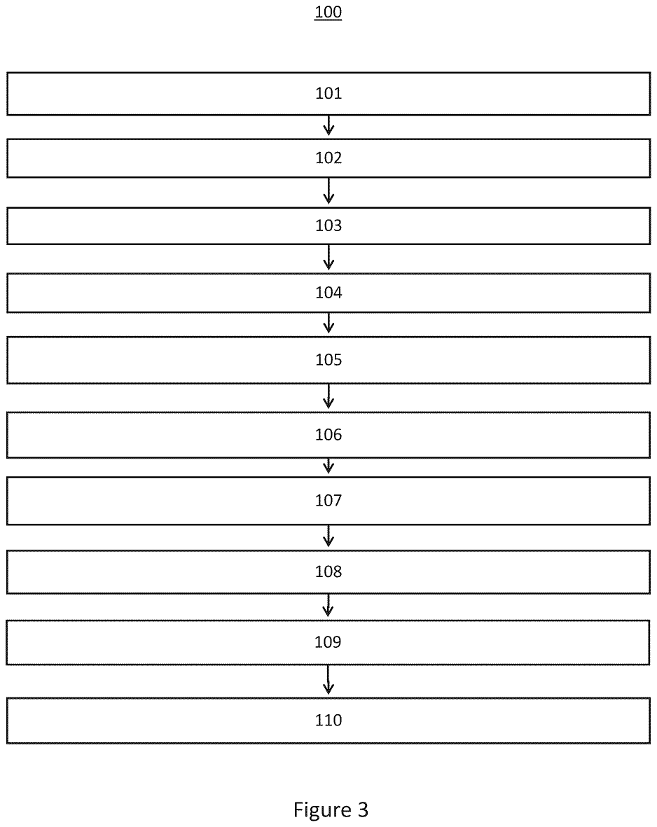

Also provided herein are methods of making a shelf-stable, thermally conductive reactive compound as disclosed herein. Exemplary steps of such a method are shown in FIG. 3. More particularly, such a method 100 can comprise a first step 101 that includes selection of a desired thermal conductivity (TC), a step 102 of selecting an isocyanate-reactive and isocyanate-containing compounds to be used in a first component and second component, respectively, given total performance requirements. Step 103 comprises selecting a desired thermally conductivity filler package, and step 104 of determining the filler loading by volume, φ_{f_mixed}, in mixed formulation to achieve the desired TC. Step 105 includes determining maximum filler loading by volume, φ_{f_max_1}, that can be added into the isocyanate-reactive component (first component), while still maintaining a flowable material. Step 106 includes calculating the minimum mix ratio of the first component to the second component, using the formula Rₘᵢₙ=φ_{f_mixed}/(φ_{f_max_1}−φ_{f_mixed}). In step 107 a method to dispense, e.g. cartridge dispensing, meter-mix-dispensing, etc. is selected. Selecting a mix ratio, R, of the first component to the second component (where R≥Rₘᵢₙ) is completed in step 108. Step 109, which in some embodiments is optional, includes adjusting the isocyanate-reactive and isocyanate concentrations on the first component and second component, respectively, to achieve desired NCO index. In step 110, compositions of the first and second components are adjusted and/or optimized to achieve total performance needs which may involve repeating steps 102-108. In some embodiments, steps 101 through 110 can be performed in the order shown in FIG. 3, while in other embodiments the order of such steps can be altered as needed.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### Example 1

### Shelf Stable Reactive Compound Comparative Example/Control 1

Table 1 lists the ingredients of an isocyanate containing composition for use in component of 2K thermally conductive adhesive composition comprising an aromatic isocyanate compound, i.e. polymeric MDI, additive package, and as-received (un-dried) ATH thermally conductive filler. The mixed composition was prepared by first combining the polymeric MDI and additive package in a Hauschild mixing cup and then mixed for 60 s at 1000 rpm under no vacuum using a DAC 800.2 VAC “Hauschild” mixer. As received ATH (un-dried) was then added and mixed for 60 s at 1000 rpm under no vacuum. The sides of the container were then scraped with a spatula and lastly a final mix for 180 s at 1200 rpm under vacuum.

TABLE 1

| Ingredient | Wt % | Vol. % |
|---|---|---|
| Polymeric MDI (129 g/equiv. NCO) | 25.1 | 39.2 |
| Additive package | 0.7 | 1.4 |
| Aluminum trihydrate, as received | 74.2 | 59.4 |
| Total | 100 | 100 |

The resulting composition was stored at room temperature in a Hauschild mixing cup, blanketed under nitrogen before capping the cup, and heat-sealed in a Mylar foil bag to prevent environmental moisture ingress from the atmosphere. Cups were briefly taken out of the foils bags at determined time intervals after storage at room temperature, remixed on the Hauschild mixer for 60 s at 1600 rpm under vacuum, and tested for viscosity. Viscosity was measured at 25° C. and 0.1 s⁻¹ for 60 s, 0.5 s⁻¹ for 30 s, 1 s⁻¹ for 30 s, and 5 s⁻¹ for 30 s using a Discovery DHR-2 Rheometer equipped with a 20 mm parallel plate configuration. The average of the last 5 viscosity data points at each shear rate was taken. Samples were again blanketed under nitrogen before capping, heat-sealed, further aged at room temperature, and retested for viscosity at a later specified time.

Table 2 shows viscosity measurements on the composition as function of room temperature storage time. Viscosities rapidly increased after 7 days to a level of a solid-like paste consistency, no longer able to readily flow. Such a lack of shelf stability makes it impractical for use.

TABLE 2

| Storage Time at | Viscosity at Various Shear Rates (Pa · s) | | | |
|---|---|---|---|---|
| Room Temp (Days) | 0.1 s⁻¹ | 0.5 s⁻¹ | 1 s⁻¹ | 5 s⁻¹ |
| 0 | 1336 | 1047 | 686 | 174 |
| 7 | 9263 | 3583 | 2056 | 547 |
| 14 | 7592 | 3554 | 2048 | 520 |
| 28 | 7952 | 3851 | 2300 | 580 |

### Example 2

### Shelf Stable Reactive Compound Comparative Example/Control 2

Table 3 lists the ingredients of isocyanate-containing, thermally conductive adhesive composition comprising an aromatic isocyanate compound, i.e. polymeric MDI, additive package, molecular sieve powder (oven dried, overnight at 315° C.), and as-received (undried) ATH, silica, calcium carbonate, and titanium dioxide thermally conductive filler. The resulting composition was prepared and tested for viscosity as previously described in Example 1.

TABLE 3

| Ingredient | Wt % | Vol. % |
|---|---|---|
| Polymeric MDI (129 g/equiv. NCO) | 24.6 | 37.5 |
| Additive package | 0.3 | 0.6 |
| Molecular sieve powder, oven dried | 3.0 | 3.6 |
| Alumina trihydrate, as received | 31.5 | 24.7 |
| Silica, as received | 31.7 | 27.7 |
| Calcium carbonate, as received | 7.9 | 5.5 |
| Titanium dioxide, as received | 1.0 | 0.4 |
| Total | 100 | 100 |

Table 4 shows viscosity measurements on the composition as function of room temperature storage time. Despite the composition containing molecular sieve powder, the viscosity of composition increased nominally 2- and 4-fold after 7 and 28 days of room temperature aging, respectively. Such a lack of shelf stability makes it impractical for use.

TABLE 4

| | |
|---|---|
| Storage Time at | Viscosity at Various Shear Rates |
| Room Temp | (Pa · s) |

| (Days) | 0.1 s⁻¹ | 0.5 s⁻¹ | 1 s⁻¹ | 5 s⁻¹ |
|---|---|---|---|---|
| 0 | 60 | 25 | 18 | 11 |
| 7 | 141 | 58 | 39 | 19 |
| 14 | 110 | 52 | 38 | 20 |
| 28 | 242 | 135 | 92 | 41 |

### Example 3

### Shelf Stable Reactive Compound Comparative Example/Control 3

Table 5A lists the ingredients for each of the components of a 2K formulation based on an isocyanate reactive composition (component 1) and an isocyanate containing composition (component 2) comprising an aliphatic HDI trimer. The ingredients of the two components have been configured to achieve similar concentrations of thermally conductive filler and an NCO/OH ratio of 0.35 and bulk thermal conductivity of 2.0 when the two components are mixed at a volumetric mix ratio of 1:1 and cured and tested at room temperature. Table 5B represents the overall mixed formulation for reference.

TABLE 5A

| | | |
|---|---|---|
| Ingredient | Wt % | Vol. % |

Isocyanate Reactive Composition (Component 1)

| | | |
|---|---|---|
| Polyester polyol (342 g/equiv. OH) | 17.0 | 41.8 |
| Catalyst | 0.06 | 0.14 |
| Additive package | 1.9 | 2.8 |
| Molecular sieve powder, oven dried | 1.0 | 1.5 |
| Aluminum oxide, oven dried | 65.5 | 39.6 |
| Alumina trihydrate, oven dried | 14.6 | 14.2 |
| Total | 100 | 100 |

Isocyanate Containing Composition (Component 2)

| | | |
|---|---|---|
| HDI trimer isocyanate (193 g/equiv. NCO) | 2.7 | 6.8 |
| Additive package | 11.6 | 28.6 |
| Aluminum oxide, oven dried | 75.7 | 57.2 |
| Titanium dioxide, oven dried | 10.0 | 7.4 |
| Total | 100 | 100 |

TABLE 5B
Mixed Table 5A formula at 1:1 volumetric ratio

| Details | Wt % | Vol. % |
|---|---|---|
| Polyester polyol (342 g/equiv. OH) | 7.6 | 20.9 |
| HDI trimer isocyanate (193 g/equiv. NCO) | 1.50 | 3.40 |
| Catalyst | 0.03 | 0.07 |
| Additive package | 7.3 | 15.7 |
| Molecular sieve powder | 0.4 | 0.8 |
| Alumina powder, oven dried | 71.16 | 48.39 |
| Alumina trihydrate, oven dried | 6.5 | 7.1 |
| Titanium dioxide, oven dried | 5.6 | 3.7 |
| Total | 100.0 | 100.0 |

All thermally conductive fillers, i.e. aluminum oxide, ATH, and titanium dioxide were dried in convection oven for a minimum of 16 hours at 125° C. The individual components were prepared as previously described in Example 1. Thermal conductivity measurements were taken on cured samples that were prepared by dispensing the two components from a 50 cc, 1:1 volumetric mix ratio cartridge, equipped with a static mix tip, to form ~3.2 cm diameter samples approximately 1.0 cm thick. The sample was allowed to cure at room temperature for 24 hours followed by bulk thermal conductivity testing according to ISO 22007-2 using a Hot Disk Transient Plane Source (Model 2500 S). The reported conductivity value is the average of 3 measurements.

Table 6 shows viscosity measurements on the isocyanate containing composition (component 2) as function of room temperature storage time, tested according to the procedure described in Example 1. Despite the composition containing oven dried filler, the viscosity of composition still increased nominally 2-fold and 6-fold after 60 and 365 days, respectively, thereby compromising its shelf stability.

TABLE 6

| Storage Time at | Viscosity of Component 2 of Comparative Example 3 | | | |
|---|---|---|---|---|
| Room Temp | (Table 5A) at Various Shear Rates (Pa · s) | | | |
| (Days) | 0.1 s⁻¹ | 0.5 s⁻¹ | 1 s⁻¹ | 5 s⁻¹ |
| 0 | 816 | 422 | 313 | 170 |
| 14 | 1018 | 545 | 406 | 207 |
| 32 | 1357 | 695 | 515 | 249 |
| 60 | 1588 | 852 | 635 | 290 |
| 119 | 1997 | 1009 | 746 | 333 |
| 273 | 3108 | 1630 | 1213 | 526 |
| 365 | 4505 | 2451 | 1829 | 773 |

| | |
|---|---|
| 730 | Too viscous- unable to test |

### Example 4

### Illustrative Example—Shelf Stable Thermally Conductive Reactive Composition

Table 7A lists the ingredients for each of the components of a 2K formulation based on the same ingredients as those listed in the 2K formulation of Example 3 but configured to have a volumetric mix ratio of 10:1, no thermally conductive filler in the isocyanate containing composition (component 2), the same NCO/OH ratio of 0.35 and the same bulk thermal conductivity of 2.0 when the two components are mixed at a volumetric mix ratio of 10:1 and cured and tested at room temperature. Table 7B represents the overall mixed formulation which is identical to that of the mixed formulation previously shown in Table 5B. All thermally conductive fillers were dried under the same conditions as Example 3. Thermal conductivity sample preparation and testing was also conducted according to Example 3.

TABLE 7A

| | | |
|---|---|---|
| Ingredient | Wt % | Vol. % |

Isocyanate Reactive Composition (Component 1)

| | | |
|---|---|---|
| Polyester polyol (342 g/equiv. OH) | 7.9 | 23.0 |
| Catalyst | 0.03 | 0.08 |
| Additive package | 4.7 | 11.0 |
| Molecular sieve powder | 0.5 | 0.8 |
| Alumina powder, oven dried | 74.3 | 53.2 |
| Alumina trihydrate, oven dried | 6.8 | 7.8 |
| Titanium dioxide, oven dried | 5.8 | 4.1 |
| Total | 100 | 100 |

Isocyanate Containing Composition (Component 2)

| | | |
|---|---|---|
| HDI trimer isocyanate (193 g/equiv. NCO) | 35.4 | 37.4 |
| Additive package | 64.6 | 62.6 |
| Total | 100 | 100 |

TABLE 7B
Mixed Table 7A formula at 10:1 volumetric ratio

| Details | Wt % | Vol. % |
|---|---|---|
| Polyester polyol (342 g/equiv. OH) | 7.6 | 20.9 |
| HDI trimer isocyanate (193 g/equiv. NCO) | 1.50 | 3.40 |
| Catalyst | 0.03 | 0.07 |
| Additive package | 7.3 | 15.7 |
| Molecular sieve powder | 0.4 | 0.8 |
| Alumina powder, oven dried | 71.16 | 48.39 |
| Alumina trihydrate, oven dried | 6.5 | 7.1 |
| Titanium dioxide, oven dried | 5.6 | 3.7 |
| Total | 100.0 | 100.0 |

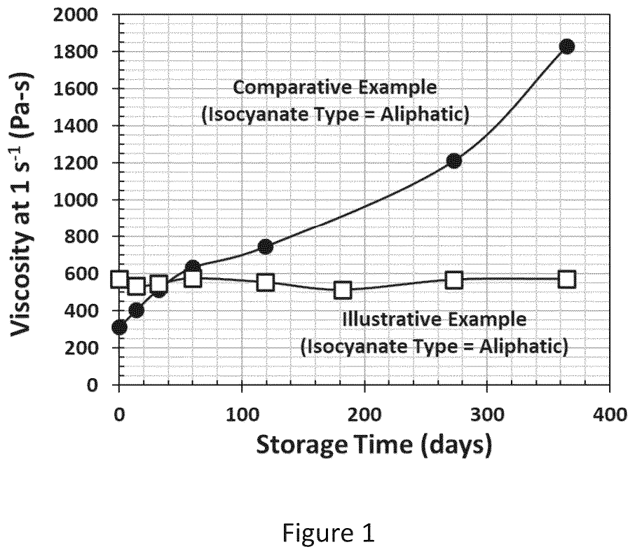

Table 8 shows viscosity measurements on the isocyanate containing composition (component 2) as function of room temperature storage time, tested according to the procedure described in Example 1. Unlike the results for Example 3, the viscosity of Example 4 is stable over the course of 730 days. FIG. 1 illustrates the differences in viscosity as function of storage time for the two examples.

TABLE 8

| Storage Time at | Viscosity of Component 2 of Illustrative Example 4 | | | |
|---|---|---|---|---|
| Room Temp | (Table 7A) at Various Shear Rates (Pa · s) | | | |
| (Days) | 0.1 s⁻¹ | 0.5 s⁻¹ | 1 s⁻¹ | 5 s⁻¹ |
| 0 | 1404 | 732 | 572 | 155 |
| 14 | 1366 | 727 | 536 | 146 |
| 32 | 1181 | 770 | 546 | 148 |
| 60 | 1164 | 868 | 576 | 156 |
| 119 | 1056 | 870 | 555 | 149 |
| 182 | 1290 | 807 | 515 | 139 |
| 273 | 1215 | 931 | 569 | 152 |
| 365 | 1170 | 981 | 573 | 152 |
| 730 | 1203 | 946 | 553 | 147 |

### Example 5

### Illustrative Example—Shelf Stable Thermally Conductive Reactive Composition

Table 9 lists the ingredients of a 2K formulation based on an isocyanate reactive composition (component 1) containing all ATH thermally conductive filler and an isocyanate containing composition (component 2) containing an aromatic, polymeric MDI and no thermally conductive filler. The components have been designed to have an NCO/OH ratio of 1.1 and thermally conductive filler of 2.0 W/m·K when mixed at a volumetric mix ratio of 10:1 and cured and tested at room temperature.

TABLE 9

| | | |
|---|---|---|
| Ingredient | Wt % | Vol. % |

Isocyanate Reactive Composition (Component 1)

| | | |
|---|---|---|
| Polyether polyol (303 g/equiv. OH) | 12.7 | 24.7 |
| Additive package | 1.4 | 2.6 |
| Catalyst | 0.01 | 0.02 |
| Molecular sieve powder, oven dried | 3.0 | 3.9 |
| Alumina trihydrate, as-received | 82.9 | 68.8 |
| Total | 100 | 100 |

Isocyanate Containing Composition (Component 2)

| | | |
|---|---|---|
| Polymeric MDI (129 g/equiv. NCO) | 93.0 | 96.2 |
| Additive package | 7.0 | 3.8 |
| Total | 100 | 100 |

The ATH filler was used as-received (undried). Thermal conductivity sample preparation and testing was conducted according to Example 3.

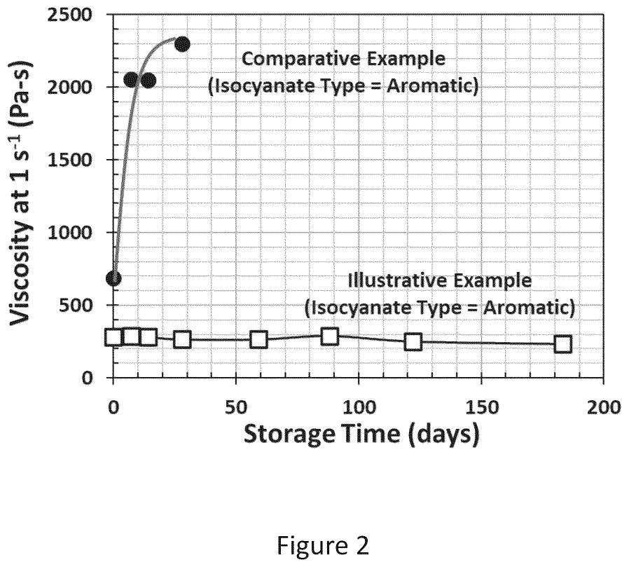

Table 10 shows viscosity measurements on the isocyanate containing composition (component 2) as function of room temperature storage time, tested according to the procedure described in Example 1. The viscosity remains stable over the entire 183 days tested. For comparative purposes, this behavior, as shown in FIG. 2, is counter to what is observed in Example 1 whose composition contains hydroscopic, thermally conductive filler.

TABLE 10

| | Viscosity of Component 2 of Illustrative | | | |
|---|---|---|---|---|
| Storage Time at | Example 5 | | | |
| Room Temp | (Table 9) at Various Shear Rates (Pa · s) | | | |
| (Days) | 0.1 s⁻¹ | 0.5 s⁻¹ | 1 s⁻¹ | 5 s⁻¹ |
| 0 | 1866 | 498 | 281 | 66 |
| 7 | 1806 | 529 | 286 | 64 |
| 14 | 1880 | 528 | 282 | 63 |
| 28 | 1657 | 478 | 265 | 59 |
| 59 | 1632 | 485 | 265 | 59 |
| 88 | 1666 | 513 | 290 | 64 |
| 122 | 1645 | 462 | 252 | 56 |
| 183 | 1584 | 431 | 234 | 51 |

### Example 6

### Illustrative Example—Shelf Stable Thermally Conductive Reactive Composition

Table 11 lists the ingredients of a 2K formulation based on an isocyanate reactive composition (component 1) containing all ATH thermally conductive filler and an isocyanate containing composition (component 2) containing a prepolymer based on MDI and no thermally conductive filler. The components have been designed to have an NCO/OH ratio of 1.1 and thermally conductive filler of 1.5 W/m·K when mixed at a volumetric mix ratio of 4:1 and cured and tested at room temperature. The ATH filler was used as-received (undried). Thermal conductivity sample preparation and testing was conducted according to Example 3.

TABLE 11

| | | |
|---|---|---|
| Ingredient | Wt % | Vol. % |

Isocyanate Reactive Composition (Component 1)

| | | |
|---|---|---|
| Polyether polyol (213 g/equiv. OH) | 12.3 | 24.4 |
| Additive package | 1.5 | 2.9 |
| Catalyst | 0.01 | 0.02 |
| Molecular sieve powder, oven dried | 3.0 | 3.9 |
| Alumina trihydrate, as received | 83.2 | 68.8 |
| Total | 100 | 100 |

Isocyanate Containing Composition (Component 2)

| | | |
|---|---|---|
| MDI-based polyether prepolymer (222 g/equiv. NCO) | 93.0 | 96.4 |
| Additive package | 7.0 | 3.6 |
| Total | 100 | 100 |

### Example 7

### Illustrative Example—Shelf Stable Thermally Conductive Reactive Composition

Table 12 lists the ingredients of a 2K formulation based on an isocyanate reactive composition (component 1) containing all ATH thermally conductive filler and an isocyanate containing composition (component 2) containing a prepolymer based on MDI and no thermally conductive filler. The components have been designed to have an NCO/OH ratio of 1.1 and thermally conductive filler of 0.94 W/m·K when mixed at a volumetric mix ratio of 2:1 and cured and tested at room temperature. The ATH filler was used as-received (undried). Thermal conductivity sample preparation and testing was conducted according to Example 3.

TABLE 12

| | | |
|---|---|---|
| Ingredient | Wt % | Vol. % |

Isocyanate Reactive Composition (Component 1)

| | | |
|---|---|---|
| Polyether polyol (213 g/equiv. OH) | 14.8 | 28.5 |
| Catalyst | 0.01 | 0.03 |
| Additive package | 1.8 | 3.3 |
| Molecular sieve powder, oven dried | 2.9 | 3.7 |
| Alumina trihydrate, as received | 80.5 | 64.5 |
| Total | 100 | 100 |

Isocyanate Containing Composition (Component 2)

| | | |
|---|---|---|
| MDI based prepolymer (371 g/equiv. NCO) | 96.6 | 98.3 |
| Additive package | 3.4 | 1.7 |
| Total | 100 | 100 |

1. A filled compound comprising:
an isocyanate reactive resin;
a conductive filler; and
an isocyanate resin,
wherein the isocyanate reactive resin and conductive filler are included in a first component,
wherein the isocyanate resin is included in a second component, and
wherein the first and second components are configured to be mixed to react to form a thermally conductive compound, wherein the first component and the second component are mixed at a ratio of about 1:1 to about 50:1.

2. The filled compound of claim 1, wherein the first component and the second component are mixed at a ratio of about 1:1, about 2:1, about 3:1, about 4:1, about 5:1, about 6:1, about 7:1, about 8:1, about 9:1, about 10:1, about 11:1, about 12:1, about 15:1, about 20:1, about 25:1, about 30:1, about 35:1, about 40:1, about 45:1, or about 50:1, or about 1:1.

3. The filled compound of claim 1, wherein the isocyanate reactive resin comprises a resin type selected from the group consisting of a polyether, polyester, and aliphatic hydrocarbon.

4. The filled compound claim 3, wherein the isocyanate reactive resin comprises:
at least two active hydrogen atoms that are selected from the group consisting of a hydroxyl, primary amine, secondary amine, thiol, urethane, urea, carboxylic acid, amide, and water; or
a polyethylene glycol, polypropylene glycol, polytetramethylene ether glycol, a castor oil-based polyester polyol, and/or a polybutadiene-based aliphatic polyol.

5. (canceled)

6. The filled compound of claim 1, wherein the isocyanate resin comprises an aromatic isocyanate, an aliphatic isocyanate, or an isocyanate prepolymer.

7. The filled compound of claim 6, wherein:
the aromatic isocyanate resin comprises a monomer or polyisocyanate based on methylene diphenyl diisocyanate (MDI) or toluene diisocyanate (TDI); or
the aliphatic isocyanate resin comprises a monomeric isocyanate or polyisocyanate based on hexamethylene diisocyanate (HDI), hydrogenated MDI, or isophorone diisocyanate.

8. (canceled)

9. The filled compound of claim 6, wherein the isocyanate prepolymer comprises a reaction product of an isocyanate reactive resin and an aromatic isocyanate resin.

10. The filled compound of claim 9, wherein the isocyanate prepolymer comprises a reaction product of a polyether polyol and an MDI-based resin.

11. The filled compound of claim 6:
wherein the isocyanate prepolymer comprises a reaction product of an isocyanate reactive resin and an aliphatic isocyanate resin; or
wherein the isocyanate prepolymer comprises a reaction product of a polyether polyol and an HDI-based resin.

12. (canceled)

13. The filled compound of claim 1, wherein the conductive filler comprises aluminum, aluminum trihydrate, aluminum oxide, silica, calcium carbonate, magnesium oxide, and/or magnesium hydroxide, or wherein the conductive filler is greater than about 5 W/m·K.

14. The filled compound of claim 1, wherein the first component comprises:
undried thermally conductive filler; or
a moisture scavenger:or
a dried filler and no molecular sieves.

15. (canceled)

16. The filled compound of claim 1, wherein the thermal conductivity ranges from about 0.5 W/m·K to about 10 W/m·K or more, or about 1 W/m·K to about 4 W/m·K.

17. The filled compound of claim 1, wherein the filled compound:
is used as a thermal interface material; or
is used as an encapsulant or potting compound.

18. (canceled)

19. The filled compound of claim 17, wherein the thermal interface material is shelf-stable.

20. The filled compound of claim 1, wherein the filled compound comprises a thermally conductive filler, a reinforcing filler, cost reducing filler, surface modifying filler, electrically conductive filler, magnetic filler, density reducing filler, and/or combinations thereof.

21. A thermal interface material formed from the compound of claim 1, the thermal interface material formed by mixing the first component with the second component.

22. A method of making a shelf-stable thermal interface material, the method comprising mixing the first component with the second component from claim 1.

23. The method of claim 22, wherein the method comprises ensuring there is no thermally conductive filler in the second component.

24. A method of making a shelf-stable thermal interface material, the method comprising:
selecting a desired thermal conductivity;
selecting isocyanate-reactive and isocyanate-containing compounds to be used in a first component and a second component, respectively;
selecting a desired thermally conductive filler package;
determining a filler loading by volume, φ_{f_mixed}, in mixed formulation to achieve the desired thermal conductivity;
determining the maximum filler loading by volume, φ_{f_max_1}, that can be added into the first component, while still maintaining a flowable material;
calculating the minimum mix ratio of the first component to the second component, using the formula Rₘᵢₙ=φ_{f_mixed}/(φ_{f_max_1}−φ_{f_mixed});
selecting a method to dispense, e.g. cartridge dispensing, meter-mix-dispensing, the material;
selecting a mix ratio, R, of the first component to the second component (where R≥Rₘᵢₙ); and
optimizing and/or adjusting compositions of the first and second components to achieve total performance needs.

25. The method of claim 24, further comprising adjusting isocyanate-reactive and isocyanate concentrations on the first component and second component, respectively, to achieve a desired NCO index.
